(19) United States
(12) Patent Application Publication
(10) Pub. No.: US 2026/0371027 A1
(43) Pub. Date: Nov. 19, 2026

(54) A METHOD OF MIXING AUDIO FOR A VIRTUAL AUDIENCE

(71) Applicant: PLAUDEO LIMITED, Shefford (GB)

(72) Inventor: David WHITTLES, Derbyshire (GB)

(21) Appl. No.: 19/132,149

(22) PCT Filed: Nov. 22, 2023
(86) PCT No.: PCT/GB2023/053053

§ 371 Date: May 22, 2025

(30) Foreign Application Priority Data
Nov. 22, 2022 (GB) 2217475.9

(51) Int. Cl. H04S 7/00; H04N 21/233; H04N 21/81

(52) U.S. Cl. CPC H04S 7/302; H04N 21/233; H04N 21/8106; H04S 2400/11; H04S 2400/15; H04S 2420/01

(57) ABSTRACT

A computer-implemented method of mixing audio for a virtual audience of a broadcast performance. Individual audience members of the virtual audience participate via respective user terminals. Each audience member has a respective virtual position in a model of a real-world performance venue for sending and/or receiving audio signals. The method comprises: obtaining a plurality of audio input signals sent from respective audience members, each audio input signal being captured via the respective user terminal; and determining one or more audio output signals for output to respective receiving audience members via the respective user terminals, each audio output signal being determined by adjusting one or more of the plurality of audio input signals-to account for: (i) the respective sets of acoustic characteristics associated with the virtual positions of the audience members sending and receiving that audio input signal; and (ii) a spatial relationship between the virtual positions of the audience members.

### TECHNICAL FIELD

The present disclosure relates generally to a method of mixing audio for a virtual audience of a broadcast performance. Aspects of the disclosure relate to a method, to a system, and to a non-transitory, computer-readable storage medium.

### BACKGROUND

Performances, such as sporting events and concerts, are typically televised or otherwise broadcast for playback on a device, such as a television or computing device, allowing a wider audience to enjoy the performance remotely. However, the remote audience experience is less immersive than the in-person experience. In-part, this is due to the inferior sound quality and the inability to contribute to the atmosphere or adequately share the experience with others, as part of an audience.

Advancements in video and audio compression technologies have increased the capabilities of web-based communications, which may be implemented with lower infrastructure requirements and at lower costs. Such developments have enabled web-based communications to support browser-to-browser applications such as voice calling, video chat, and peer-to-peer (P2P) file sharing applications, for example using the web real-time communication (WebRTC) standard, while avoiding the need for plugins to connect communication endpoints.

The developments have therefore enabled simultaneous video streaming and audio sharing between small groups of remote audience members. However, for many, the experience is still greatly inferior to the in-person experience.

It is against this background that the disclosure has been devised.

### SUMMARY OF THE DISCLOSURE

According to an aspect of the invention, there is provided a computer-implemented method of mixing audio for a virtual audience of a broadcast performance. Individual audience members of the virtual audience participate via respective user terminals. Each audience member has a respective virtual position in a model of a real-world performance venue for sending and/or receiving audio signals. For example, each audience member may select or be assigned a respective virtual position. The virtual positions are associated with respective sets of acoustic characteristics for modelling acoustic responses of the real-world performance venue at corresponding real-world positions. The method comprises: obtaining a plurality of audio input signals sent from respective audience members, each audio input signal being captured via the respective user terminal; and determining one or more audio output signals for output to respective receiving audience members via the respective user terminals, each audio output signal being determined by adjusting one or more of the plurality of audio input signals to account for: (i) the respective sets of acoustic characteristics associated with the virtual positions of the audience members sending and receiving that audio input signal; and (ii) a spatial relationship between the virtual positions of the audience members respectively sending and receiving that audio input signal.

In this manner, individuals can attend a broadcast performance remotely, regardless of their real-world geographical location, and use a two-way audio device to listen and talk to friends, family or other audience members in close virtual proximity, whilst cheering, clapping, or otherwise communicating with more virtually distant audience members. The method advantageously adjusts the audio received from respective audience members to account for the acoustic effects, such as the reflection and absorption, that would occur in the real-world performance venue when sound is transmitted between a source and a receiver. This is achieved by taking into account the acoustic characteristics at respective transmitting and receiving positions in the virtual model and the spatial relationship between those transmitting and receiving positions. Consequently, the method is able to deliver audio output signals that sound authentic to the receiving audience members, reproducing the acoustic responses of the real-world performance venue and creating a more immersive experience.

For this purpose, each user terminal may, for example, include a computer terminal or processing device equipped with, or otherwise connected to: (i) one or more audio devices for capturing user audio and providing audio playback, and (ii) one or more video devices or display screens for video playback. For example, each user terminal may include any suitable computer hardware or processing device, such as a mobile phone, computer or media player, connected to a microphone headset and a display screen, such as a television.

In an example, the method further comprises: obtaining one or more (time-stamped) broadcast audio and/or video signals from a media source broadcasting the performance; and outputting the one or more audio output signals to the respective receiving audience members, via the respective user terminals, synchronously with the one or more broadcast audio and/or video signals. For this purpose, the audio input signals and/or the audio output signals may also be timestamped, for example. In this manner, the audience member can watch the performance, such as a football match, whilst hearing the accompanying noise of the virtual audience.

Optionally, each set of acoustic characteristics comprises one or more parameters of an impulse response of the performance venue at the corresponding real-world position. For example, such parameters may include: forward early reflection, reverse early reflection, Initial Time Delay Gap, and/or Late Reverberation values. In this manner, the set of acoustic characteristics can be used to impart the real-world reverberant characteristics of the performance venue onto the audio signals. The impulse response may be a binaural room impulse response of the performance venue at the corresponding real-world position, for example.

Optionally, one or more of the sets of acoustic characteristics are determined by physically measuring the impulse response of the real-world performance venue at the corresponding real-world position.

In an example, one or more of the sets of acoustic characteristics are computationally derived. Optionally, one or more of the sets of acoustic characteristics are computationally derived based on one or more physical measurements of the impulse response of the performance venue. For example, one or more sets of acoustic characteristics may be computationally derived for respective virtual positions based on the measured acoustic characteristics at one or more surrounding or adjacent virtual positions, for example by interpolation or extrapolation

Optionally, the method further comprises associating the virtual audience with a plurality of user bubbles. For example, the virtual audience may be divided into a plurality of user bubbles. Each user bubble may be associated with two or more of the audience members. For example, each user bubble may be associated with up to N audience members, where N is a positive integer, limiting the size of the user bubbles. For example N may be a value of 10 or 100. Determining each audio output signal for output to the respective receiving audience member comprises: identifying the user bubble associated with that receiving audience member; adjusting the audio input signals sent from the other audience members of the identified user bubble according to a first audio processing method; and adjusting the audio input signals sent from the audience members of the other user bubbles according to a second audio processing method. In this manner, audio input signals sent from outside the user bubble of the receiving audience member are processed according to a different method to the audio input signals sent from inside the same user bubble as the receiving audience member. This allows for scalability by reducing processing requirements.

Optionally, the first audio processing method comprises: adjusting each audio input signal sent from one of the audience members of that user bubble to account for the respective set of acoustic characteristics associated with the virtual position of that audience member, thereby forming a respective intra-bubble audio signal for each audience member of the identified user bubble.

Optionally, each user bubble has a virtual position in the modelled performance venue, and a respective set of acoustic characteristics, based on the audience members associated with that user bubble. For example, the virtual position of the user bubble may correspond to an average or representative virtual position of the audience members of that user bubble. Similarly, the set of acoustic characteristics may correspond to the acoustic characteristics of that virtual position. The second audio processing method comprises: compositing the audio input signals sent from the audience members of each of the other user bubbles into a respective inter-bubble audio signal for each user bubble; and adjusting each inter-bubble audio signal to account for the respective set of acoustic characteristics associated that user bubble, thereby forming a respective extra-bubble audio signal for each user bubble. Compositing the audio input signals in this manner reduces the processing efforts required to apply the acoustic characteristics for example.

Optionally, determining each audio output signal for output to the respective receiving audience member further comprises: adjusting each intra-bubble audio signal to account for: (i) the set of acoustic characteristics associated with the virtual position of the audience member receiving that audio output signal and (ii) the spatial relationship between the virtual position of the audience member sending that intra-bubble audio signal and the virtual position of the audience member receiving that audio output signal; and/or adjusting each extra-bubble audio signal to account for: (i) the set of acoustic characteristics associated with the virtual position of the audience member receiving that audio output signal and (ii) the spatial relationship between the virtual position of the user bubble sending that extra-bubble audio signal and the virtual position of the audience member receiving that audio output signal.

In an example, the first and second audio processing methods are executed simultaneously.

Optionally, the audio signal adjustments to account for the respective set of acoustic characteristics comprise applying one or more convolution algorithms to convolute the respective audio signal with the respective set of acoustic characteristics.

In an example, the audio signal adjustments to account for the spatial relationships between the respective virtual positions of the sending and receiving audience members comprise applying one or more transforms to the audio signal according to the respective spatial relationship.

Optionally, the determined one or more audio output signals are three-dimensional signals, i.e. spatial audio signals.

Optionally, the steps of obtaining the plurality of audio input signals and determining the one or more audio output signals are performed centrally on one or more mixer-servers (to which the user terminals are connected).

According to another aspect of the invention, there is provided a computer-implemented method of mixing audio for an audience member of a broadcast performance. The audience member is part of a virtual audience along with a plurality of connected audience members. The audience member and each connected audience member participate via a respective user terminal and have a respective virtual position in a model of a real-world performance venue. The virtual positions are associated with respective sets of acoustic characteristics for modelling acoustic responses of the real-world performance venue at corresponding real-world positions. the method comprises: obtaining a plurality of audio input signals sent from the connected audience members, each audio input signal being captured via the respective user terminal and adjusted to account for the set of acoustic characteristics associated with the virtual position of the connected audience members sending that audio input signal; and determining an audio output signal for output to the audience member via the respective user terminal, the audio output signal being determined by adjusting one or more of the plurality of audio input signals to account for: (i) the set of acoustic characteristics associated with the virtual position of the audience member receiving the audio output signal; and (ii) a spatial relationship between the virtual positions of the receiving audience member and the connected audience member sending that audio input signal.

According to another aspect of the invention, there is provided a computer-readable storage medium comprising instructions that, when executed by a computer, cause the computer to perform a method as described in a previous aspect of the invention.

According to a further aspect of the invention, there is provided an audio mixing system comprising: a media source for broadcasting a performance; one or more mixer servers; and a plurality of user terminals operably connected to the one or more mixer server(s) via a communication network. A virtual audience is formed for the broadcast performance by a plurality of audience members participating via respective ones of the plurality of user terminals. Each audience member has a respective virtual position in a model of a real-world performance venue. The virtual positions are associated with respective sets of acoustic characteristics for modelling acoustic responses of the performance venue at corresponding real-world positions. The one or more mixer-servers are configured to execute instructions to: obtain a plurality of audio input signals sent from respective audience members during the broadcast performance, each audio input signal being captured via the respective user terminal; and determine one or more audio output signals for output to respective receiving audience members via the respective user terminals, each audio output signal being determined by adjusting one or more of the plurality of audio input signals to account for: (i) the sets of acoustic characteristics associated with the virtual positions of the audience members respectively sending and receiving those audio input signals; and (ii) a spatial relationship between the virtual positions of the audience members respectively sending and receiving those audio input signals.

Optionally, each user terminal comprises one or more audio devices for: capturing audio from a user to generate audio input signals; and playback of audio output signals to the user.

Optionally, each user terminal comprises one or more video devices for playback of one or more time-stamped broadcast audio and/or video signals generated by the media source.

In an example, the media source is configured to generate one or more time-stamped broadcast audio and/or video signals. The one or more mixer-servers may be configured to execute instructions to output the one or more audio output signals to the respective receiving audience members, via the respective user terminals, synchronously with the one or more broadcast audio and/or video signals.

It will be appreciated that preferred and/or optional features of each aspect of the disclosure may be incorporated alone or in appropriate combination in the other aspects of the disclosure also.

### BRIEF DESCRIPTION OF THE DRAWINGS

Examples of the disclosure will now be described with reference to the accompanying drawings, in which:

FIG. 1 shows a schematic view of an exemplary audio mixing system, according to the present disclosure;

FIG. 2 shows a schematic view of an exemplary virtual model of a performance venue, according to the present disclosure;

FIG. 3 shows a schematic view of grouping of audience members into user bubbles for audio mixing;

FIG. 4 shows exemplary steps of a method of generating an audio input signal from a user terminal of the audio mixing system shown in FIG. 1;

FIG. 5 shows the steps of an example method of mixing audio for a virtual audience of a broadcast performance using the audio mixing system shown in FIG. 1;

FIG. 6 shows exemplary sub-steps of the method of mixing audio shown in FIG. 5; and

FIG. 7 shows exemplary steps of a method of processing an audio output signal, received at a user terminal of the audio mixing system shown in FIG. 1, for playback.

### DETAILED DESCRIPTION

Embodiments of the disclosure relate to a method, and to a system, for mixing audio for a virtual audience of a broadcast performance, which may be a sporting event or musical performance for example. The audience members participate via respective user terminals and each audience member is assigned or selects a virtual speaking and listening position within a virtual replica (or model) of a real-world performance venue.

The real-world performance venue may be the real-world setting of the performance, such as a stadium, concert hall, or other venue, where the performance takes place, or any other real-world performance venue that has been modelled.

Each virtual position is associated with a set of acoustic characteristics (that may be measured and/or computationally derived), which are used to adapt audio signals transmitted from, and received by, the respective user terminal in order to accurately simulate the acoustic responses of the real-world performance venue. In particular, the set of acoustic characteristics associated with each virtual position accurately model a reverb signature or impulse response of the performance venue at the corresponding real-world position. The set of acoustic characteristics may therefore be used by one or more audio processing techniques, or convolution algorithms, to adapt audio signals transmitted or received by the respective user. In this manner, the audio signals are adapted to impart the real-world frequency-specific reverberations of a corresponding position in the real-world performance venue.

Advantageously, the audio mixing system therefore uses the virtual position of each audience member, and the corresponding set of real-world acoustic characteristics, to mix audio inputs from peer users watching the same performance and determine respective spatial audio output signals, synchronised with the broadcast, for each user. This has the effect of replicating the sound that users would experience in-person at the real-world performance venue.

Individuals can therefore attend a broadcast performance remotely, regardless of their real-world geographical location, and use a two-way audio device to listen and talk to friends, family or other audience members in close virtual proximity, whilst cheering, clapping, or otherwise contributing to the sound experienced by more virtually distant audience members.

It is expected that the audio mixing method and system will therefore provide a spatialised sound output for each user that accurately reproduces the acoustic qualities of the real-world performance venue. In this manner the invention provides a more immersive experience for enjoying broadcast performances.

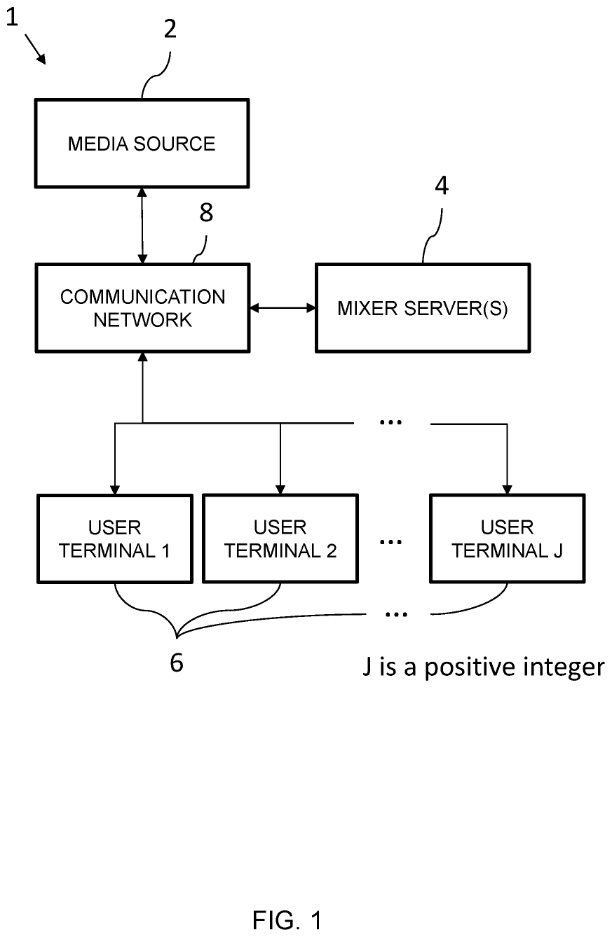

The audio mixing system shall now be discussed in more detail with reference to FIG. 1, which schematically illustrates an exemplary audio mixing system 1 in accordance with an embodiment of the invention. The example architecture of the audio mixing system is not intended to be limiting on the scope of the invention though and, in other examples, it shall be appreciated that the architecture may take other suitable forms.

As shown in FIG. 1, the audio mixing system 1 includes a media source 2, one or more mixer servers 4, and a plurality of user terminals 6 operably connected to the mixer server(s) 4 during a performance, via a communications network 8.

The media source 2 may take various suitable forms within the scope of the present disclosure, each providing a live broadcast, including audio and/or video signals, relating to an event or performance.

To give an example, the broadcast performance may take the form of a live streamed football match provided by a television network, and the media source 2 may serve as the interfacing equipment transmitting the broadcast audio and video signals for distribution to individual user terminals 6.

In this respect, although the media source 2 provides a live or real-time broadcast to the audience members, the performance itself may be pre-recorded or a live event. In other words, the performance can be recorded and subsequently replayed allowing the virtual audience to participate in the event, in real time, as it is broadcast. For example, the broadcast performance may be a repeat or a rerun of a performance, which has been performed previously. It is therefore envisaged that the broadcast performances could take all manner of forms, from live or historic sporting events, to concerts, theatrical performances and comedy shows. The media source 2 may therefore include any TV broadcasting, internet broadcast, or other mass media distribution systems.

In each case, the broadcast audio and video signals produced by the media source 2 are time-stamped to produce a reference timeline. Broadcast signals may also be transmitted in synchronous form for ease of subsequent processing, as shall be described in more detail below.

In examples, the media source 2 may transmit a plurality of audio and/or video signals corresponding to respective components or layers of the broadcast performance. For example, during a broadcast football match, the audio signals may include several separate audio layers, including respective live audio feeds from: the playing surface, the announcer and/or commentator, the crowd, and/or any additional sound sources. Such audio layers can subsequently be mixed together to produce the desired mix of sound for the audience.

The media source 2 is configured to transmit the broadcast audio and/or video signals via the communications network 8 and may transmit the broadcast audio and/or video signals to the mixer server(s) 4, for subsequent relay to the user terminals 6, or directly to the user terminals 6. Accordingly, for this purpose, the media source 2 may include one or more suitable encoders and/or transmuxers for compressing the broadcast signals and/or converting the broadcast signals to a format that is convenient for distribution, as shall be discussed in more detail.

The audience members participate or join the virtual audience via respective user terminals 6 that connect to the mixer-sever(s) 4 and form part of the audio mixing system 1 during the broadcast performance.

For this purpose, each user terminal 6 may therefore include any suitable computer hardware or processing device, such as a mobile phone, computer or media player, equipped with, or otherwise connected to: (i) one or more audio devices (including microphones and/or speakers) for capturing user audio and providing audio playback, and (ii) one or more video devices or display screens for video playback.

In this context it shall be appreciated that the user experience will partly depend on the type and quality of the sound recording and playback devices. Therefore recommendations and minimum requirements for microphone recording devices and/or speakers may be provided for the user terminals 6 of the audio mixing system 1.

In many cases, it is anticipated that users will watch the broadcast performance on a television, such as a Smart TV or similar display device, connected to the user terminal 6, and use separate audio device(s), such as a headset, or a suitable headphone/microphone combination, connected to the user terminal 6, for participating in the virtual audience. In this respect, it shall be appreciated that there are many technical possibilities for the user terminal 6.

Each user terminal 6 is configured to capture live audio, typically including the user's voice and other sounds picked up by the microphone(s), and to generate an audio input signal for transmission to the other user terminals 6, via the mixer server(s) 4. The audio input signal generated by the user terminal 6 is typically time-stamped with the time of origination for subsequent processing and synchronisation purposes. In this context, the time of origination may be recorded according to the reference timeline provided by the broadcast audio and/or video signals, or according to a generic time standard, such as UTC, for subsequent conversion to the reference timeline.

Furthermore, in order to provide each user or audience member with a personalized audio experience, and to recreate the sound that users would experience in-person, the audio mixing system 1 needs to process the audio transmitted and received by the user to account for a virtual position of the audience member within the performance venue.

Specifically, in each process, it is necessary to adapt the audio signals taking into account a virtual position of the user in the virtual audience and corresponding real-world acoustic characteristics of the modelled performance venue.

In this context, the virtual position of each audience member/user refers to an allocated position of that audience member in a model or virtual replica of a real-world performance venue. The virtual audience is therefore formed of a plurality of audience members, joining remotely via respective user terminals 6, each being associated with a respective virtual position, for example defined by x-, y- and z-co-ordinates, inside a model of a real-world performance venue.

To give an example, the audio mixing system 1 may mix audio for a virtual audience watching a broadcast football match, where the virtual audience members are associated with respective virtual positions (in this case allocated seats) inside a model of a real-world football stadium. In general, it is anticipated that the modelled performance venue used for the virtual audience will correspond to the respective real-world venue of the broadcast performance. However, this example is not intended to be limiting on the scope of the invention and, in other, examples, the virtual audience may be hosted in any one of a plurality of modelled performance venues, as shall become clear in the following description.

In general, the performance venue may therefore take the form of a concert hall, a stadium, a theatre or any other entertainment venue or performance site. Additionally, the model, or virtual replica, may take various suitable forms, for example ranging from a two-dimensional schematic representation of the performance venue to accurate three-dimensional models of the performance venue. In each case, the model will include accurate spatial data indicative of the physical dimensions of the venue and/or the spatial arrangement of the spectating positions inside the venue along with the data relating to the respective acoustic characteristics.

The virtual position of each audience member in the virtual audience may be automatically assigned or selected by the user, for example via the user terminal 6. This allows users to virtually position themselves next to, or in close proximity to, one or more friends. Users may also select or be assigned to respective user bubbles, allowing the users to communicate with other members of the bubble without the sound becoming indistinguishable over the surrounding audience noise, as shall be described in more detail. For such purposes, the user terminals 6 may also provide a graphical user interface for accessing an application or platform upon which the model of the performance venue is hosted. The graphical user interface may be comprised in a downloadable client application or a web browser application, for example using a WebRTC standard, providing the application data and instructions required to access the model of the performance venue and enable a plurality of interactions therewith. In this manner, a user may automatically or manually select a virtual position, such as a seat, within the model of the performance venue to speak and/or listen from, and may join one or more virtually proximal users in a user bubble. The user terminal 6 may therefore receive the virtual position selection and the respective user bubble information, which may be transmitted to the mixer-server(s) 4. In this manner, the virtual position of each user terminal 6 may be stored in a memory of the user terminal 6 and/or the mixer-server(s) 4, for use in mixing the audio output signal for each user accordingly.

Importantly, in order to recreate the sound that users would experience in-person, each available listening/spectating position, i.e. each virtual position, is associated with: (i) a real-world position in the performance venue; and (ii) a corresponding set of acoustic characteristics for reproducing acoustic responses of the performance venue at the real-world position (in particular acoustic responses to sound transmitted from and/or received at the real-world position). In this manner, each set of acoustic characteristics can be used to transform, and/or adapt, audio signals transmitted from, and received at, the respective virtual position, simulating the response of the real-world performance venue. In particular, each set of acoustic characteristics can be used to recreate the real-world frequency-specific reverberation at a corresponding position in the real-world performance venue and spatial data can be used to transform the audio according to the relative positions of the users, as shall be discussed in more detail.

During a broadcast performance, each user terminal 6 is therefore associated with a respective virtual position and audio signals transmitted from, and received at, that user terminal 6 will be processed using the spatial data and the corresponding sets of acoustic characteristics to impart the real-world reverberant characteristics of the performance venue onto the audio signals.

In examples, it shall be appreciated that each user terminal 6 may be further configured to perform one or more signal processing steps for preparing the captured audio signals for transmission and/or one or more signal processing steps for playback of received audio input signals. For example, prior to transmission, each user terminal 6 may be configured to process the captured audio data to improve a signal quality or transmission efficiency of the audio input using methods of normalization, echo removal, volume balancing, compression, etc. known to those skilled in the art. Such techniques are known for correcting errors so that the audio is of sufficient quality to be understood, but are not described in detail here to avoid obscuring the invention. The user terminal 6 may therefore be configured to normalise the audio and remove unwanted local spatial effects like echo and background noise, before compressing the audio input signal for distribution. For this purpose, the user terminal 6 may therefore include, or functionally operate as, an encoder and/or a transmuxer that repackages the audio data with a protocol that is most convenient for distribution, for example with minimum delay and data loss. On the receiving side, each user terminal 6 may, for example, be configured to process the received audio signal(s) using methods of volume balancing, decompression, etc. known to those skilled in the art, for playback via the user terminal 6. Again, such methods are not described in detail here to avoid obscuring the invention. However, it shall be appreciated that the user terminal 6 may therefore be configured to decode, and/or decompress audio output signals received from the mixer server(s) 4 and, for this purpose, the user terminals 6 may therefore include, or functionally operate as, a decoder and/or a transmuxer that unpackages the audio data from the distribution protocol.

It shall be appreciated that the encoders and decoders used for the processing tasks described above may be AAC or Opus codecs to suitably decrease the load on the distribution medium to the extent that tens or hundreds of thousands of audio signals can be sent over the internet. However, the examples described above are not intended to be limiting on the scope of the invention and, in other examples, the audio may be sent uncompressed to facilitate analysis or mixing. Alternatively, the audio may be sent compressed to facilitate transmission, and/or the audio signals can be sent both compressed and uncompressed to optimize processing speed over bandwidth.

The mixer server(s) 4 comprise at least one server computing device comprising processing and memory resources, along with communication network access capabilities for performing the techniques disclosed herein, such as storing, processing, mixing, routing and distributing the audio/video signals. In examples, the mixer server(s) 4 may be implemented as a cloud-based computing environment, where the functionalities of the mixer server(s) 4, described herein, are executed in a distributed fashion.

Depending on the number of audience members and the processing capabilities of the user terminals 6, the audio mixing processes executed to generate individual spatial audio output signals for playback on respective user terminals 6 may be performed: (i) centrally on the mixer-server(s) 4, referred to herein as “centralized processing”; (ii) in a partly distributed manner that involves some aspect of ‘localized processing’—locally on the user terminal 6—and other aspects of centralised processing; or (iii) in a fully distributed manner, in which the mixer server(s) 4 handle the routing and forwarding of audio signals for ‘localized processing’ on one or more user terminals 6. For example, fully distributed audio mixing may be suitable for a small number of users, where the audio output signals can be combined and mixed on each user terminal 6 without exceeding expected processing capabilities of a consumer device. However, as the number of users increases, partly distributed audio mixing, or centralised processing may be needed, utilizing the greater processing capabilities of dedicated audio mixer-server(s) 4. In particular, the partial or full processing at the mixer server(s) 4 may allow groups of audio input signals to be processed together, composited and relayed to other groups. Accordingly, for the sake of clarity, the following example describes an embodiment involving centralised processing of all of the audio mixing steps on the mixer-server(s) 4. However, this example is not intended to be limiting on the scope of the invention.

In this example, the mixer-server(s) 4 are configured to: (i) receive a multiplicity of audio input signals, also referred to as streams, from the user terminals 6; ii) mix the audio input signals together to impart the real-world acoustic characteristics and generate personalised spatial audio output signals for each user terminal 6; and (iii) send the audio output signals to each of the connected user terminal 6. The mixing must account for the relative virtual positions of the user terminals 6 (describing the spatial relationship between virtual transmitting and receiving positions) and the acoustic characteristics of the real-world performance venue associated with each virtual position. For this purpose, each user's audio must be processed on recording and on playback.

In order to accommodate thousands of users, the virtual audience may be organised into a plurality of user bubbles. Each user bubble comprises a group of audience members that are (virtually) positioned together and thus are virtually within hearing distance without the sound becoming indistinguishable. Each user bubble may therefore be defined by a respective group of virtual positions. A user may therefore select or be assigned to one such virtual position, for example via the user terminal 6, allowing friends to join the same bubble and hear each other during the broadcast performance.

Each user bubble therefore has two or more audience members (and may include up to ten audience members for example) that are able to communicate with each other during the performance, where each user's audio signal is unique inside that user bubble. Separately, and simultaneously, the original audio input signals are composited together and presented to the other user bubbles as a single composited signal for processing to form a surrounding audience noise. In other words, internally, the individualised audio inputs signals are mixed together accounting for the respective virtual positions and associated acoustic characteristics of the audience members inside that user bubble, thereby allowing the users to communicate with each other in a normal manner. However, the original audio input signals are separately composited into a single signal for distribution, externally, to the other user bubbles and each user bubble therefore sends/receives composited signals that can subsequently be mixed together to create a surrounding atmosphere.

In this respect, although there is a full-duplex experience, the implementation uses a two-way simplex concept that enables the encoders to aggregate signals and create a single composited stream that is distributed between user bubbles. Since the number of users per bubble is a variable, it is therefore possible to reduce the processing complexity without decreasing the user experience.

The mixer server(s) 4 are therefore configured to collect audio input signals from each audience member of each user bubble, and to prepare corresponding audio output signals for each audience member by performing a series of internal and external audio mixing steps, accounting for the respective virtual positions and user bubble allocations.

In particular, the mixer server(s) 4 are configured to perform: (i) intra-bubble audio processing; (ii) inter-bubble audio processing; and (iii) output audio mixing, as shall be described in more detail.

Intra-bubble audio processing relates to the audio processing within each user bubble to allow the audience members inside that user bubble to communicate with one another. The intra-bubble audio processing may therefore involve, for each user bubble, adjusting the audio input signals originating from the user terminals 6 of that user bubble to account for the respective virtual position of that user and the associated set of acoustic characteristics. The intra-bubble audio processing therefore imparts the real-world frequency-specific reverberant characteristics of the speaking position of each user inside the user bubble. The intra-bubble audio processing generates a respective set of intra-bubble audio signals from each user terminal 6.

Inter-bubble audio processing is performed separately and, in some cases, simultaneously with the intra-bubble audio processing performed at each user bubble to form a composite audio signal for each user bubble, which is distributed externally to the other user bubbles. The inter-bubble audio processing may therefore involve a first step of compositing the original audio input signals from the respective user terminals 6 of each user bubble to generate a respective inter-bubble audio signal for distribution to the other user bubbles.

In this respect, the mixer server(s) 4 may therefore include or function as a compositor system that aggregates the original audio signals together to create a single composited stream for each user bubble.

The inter-bubble audio processing may further involve a second step concerning the audio mixing processes involved in adapting each of the composited audio streams to impart the real-world frequency-specific reverberant characteristics of their respective originating virtual positions. For example, the virtual position of one or more audience members of each user bubble may be used as a representative virtual position for that user bubble and the acoustic characteristics associated with that virtual position may be considered representative for that user bubble. The inter-bubble audio processing may therefore adjust each of the received inter-bubble audio signals to account for the respective virtual position of that user bubble and the associated set of acoustic characteristics. In this manner, the inter-bubble audio processing may form a respective extra-bubble audio signal for each user bubble, which may subsequently be used to mix individual audio output signals for each user terminal of a receiving user bubble.

The output audio mixing therefore relates to the final mixing of the intra-bubble audio signals, received from within the user bubble, and the extra-bubble audio signals, received from external user bubbles, to generate a respective audio output signal for each user terminal 6. As part of the output audio mixing process, the intra-bubble audio signals and the extra-bubble audio signals are adjusted to account for the spatial relationship between the respective originating virtual positions and the respective virtual position of the receiving user terminal. In other words the intra-bubble audio signals and the extra-bubble audio signals are adjusted to account for the relative virtual positions of the speaking audience member to the listening audience member. This may be achieved using one or more transform functions relating the respective speaking positions to the respective listening positions, as would be known to the person skilled in the art. As another part of the output audio mixing process, the intra-bubble audio signals and the extra-bubble audio signals are further adjusted to impart the real-world frequency-specific reverberant characteristics of the listening position of the receiving user terminal 6. In other words, to impart the acoustic response of the real-world performance venue to the received audio. It shall be appreciated that the output audio mixing process may involve adjustment of an audio level or volume associated with each of the intra-bubble audio signals, received from within the user bubble, and the extra-bubble audio signals, received from other user bubbles. For example, the volume of the extra-bubble audio signals can be reduced so that the voices of the inter-bubble audio signals can be understood. Audience members in the same bubble would hear each other at a normal volume, while audience members in other bubbles would be heard at a reduced volume. In some examples, the volume, stereo mix, or head related transforms may be mixed by manual controls, like a mixing panel, or through an automatic process. In this manner, a broadcast engineer may be provided with access to a mixing panel to control the sound dynamically during the broadcast performance. For example, the process could involve real time data calls that would provide dynamic control over the audio output signals.

After this treatment is performed, the audio output signal can be sent to the respective user terminal 6 for synchronous audio playback with the broadcast audio and/or video signals. In this respect, it shall be appreciated that the audio output signal and the broadcast audio signal may be in separate streams, or mixed together into a single stream, for synchronous playback.

In order to accommodate thousands of users, and provide efficient distribution, it shall be appreciated that the mixer-server(s) 4 may be further configured to perform one or more signal processing steps for receiving and/or transmitting respective audio signals in the above description. For example, upon receiving the audio input signals, the audio mixer server(s) 4 may, for example, be configured to process the received audio signal(s) using methods of volume balancing, decompression, etc. known to those skilled in the art for audio mixing. Again, such methods are not described in detail here to avoid obscuring the invention. However, to give an example, the mixer server(s) 4 may be configured to decode, and/or decompress the audio signal(s) following distribution. The processor(s) may therefore include, or functionally operate as, a decoder and/or a transmuxer that unpackages the audio data from the distribution protocol. Similarly, on the transmission side, the mixer server(s) 4 may be configured to process the audio output signals to improve a transmission efficiency using methods of compression, etc. known to those skilled in the art. Such methods are not described in detail here to avoid obscuring the invention. However, to give an example, the processor(s) of the mixer server(s) 4 may include, or functionally operate as, an encoder and/or a transmuxer that repackages the audio output signals with a protocol that is supported by the audio decoder of the user terminals 6 and is most convenient for distribution, for example with minimum delay and data loss. For example, it shall be appreciated that the mixer server(s) 4 may use encoders and decoders, such as AAC or Opus, for the above tasks to decrease the load on the distribution medium to the extent that tens of thousands of audio signals can be sent over the internet. However, the examples described above are not intended to be limiting on the scope of the invention and, in other examples, the audio signals may be sent/received uncompressed to facilitate analysis or mixing. Alternatively, the audio signals may be sent/received in a compressed state to facilitate transmission, and/or the audio signals can be sent/received both compressed and uncompressed to optimize processing speed over bandwidth.

In the context of such audio mixing and distribution via the communication network 8, the synchronization of the various audio signals with the broadcast audio/video signals is another important factor of the audio mixing system 1.

For example, the audio coming from peer users that watch the same event must be adequately synchronized, and not precede the broadcast video on the connected display device, otherwise a user may hear other participants cheering for a goal scored during a football match, before being able to witness the goal.

In order to achieve adequate synchronisation, one or more synchronisation methods, schemes, and/or protocols may be used that are known to the skilled person in the art for timeline synchronisation between the audio input/output signals transmitted from/received at the user terminals 6 and the broadcast audio and/or video signals.

Such methods are not described in detail here to avoid obscuring the invention, however it shall be appreciated that all user clocks may therefore be approximately synchronized with reference to a separate timing reference or “Wall Clock” established as a common reference. In this manner, one or more companion screen applications on the user terminals 6 and/or the mixer server(s) 4 can compensate for network latency. For example, the mixer server(s) 4 may therefore be configured to deliberately delay the broadcast audio and/or video signals to allow for suitable processing, where the delay parameter may be a variable with a maximum threshold. In this manner, a dynamic situation is created, allowing the synchronization to be controlled—automatically or manually—and tuned to give the users an optimal composite experience.

To give a non-limiting example, the principles of the digital video broadcasting standard, ETSI TS 103286-2, may be used for this purpose. ETSI TS 103286-2 specifies an architecture and protocols for content identification, timeline synchronization and trigger events for companion screens and streams. The application of ETSI TS 103286-2 to the audio mixing system 1 of the present invention for the purposes of synchronising the audio input/output signals from the user terminals 6 and the broadcast audio and/or video signals shall be readily understood by the person skilled in the art.

In this manner, it shall be appreciated that the audio mixing described above may be performed on a plurality of synchronous audio input signals obtained from respective audience members.

Returning to FIG. 1, the communication network 8 includes one or more distributor(s) providing the network, equipment and capacity to distribute the signals between the media source 2, the user terminals 6 and the mixer-server(s) 4.

As mentioned previously, sending multiple (thousands of) audio signals over the internet may cause congestion and high bandwidth consumption, which may lead to unacceptable download times. Accordingly, in some examples, the communication network 8 may use a particular transport protocol for transporting and compressing the audio signals. Suitable transport protocols for distributing the audio signals in the audio mixing system 1 are WebRTC and SRT1, or RIST2 which is a similar transport protocol. HESP3 may also be used, since it is based on HTTP, providing ultra-low latency. The communication network 8 may therefore include a combination of these protocols and a cluster of “signal-repeaters”, or servers, to distribute the complete package of audio signals to the audience members, in real-time, and with spatial sound.

Accordingly, the user terminals 6 and/or the mixer-sever(s) 4 may use an Opus codec, for example, for distributing the audio signals over WebRTC, for example from a web browser, or use an Opus or AAC codec for distributing the audio signals over SRT from an application. The mixer server(s) 4 may have to perform transcoding (converting from one codec to another) if more than one audio codec is used in the implementation.

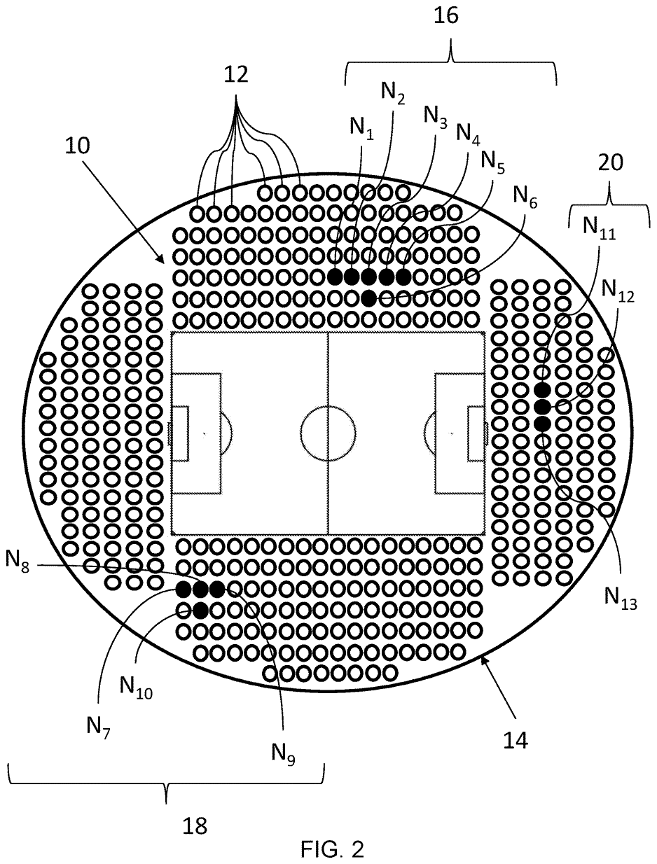

A method 100 of operating the audio mixing system 1 to mix audio for a virtual audience of a broadcast performance shall now be described with reference to FIGS. 2 to 7.

For the purposes of the following description it shall be appreciated that the media source 2 broadcasts a performance, in real-time, and a virtual audience is formed for the performance by a plurality of user terminals 6, connected to the audio mixing system 1 via the communication network 8.

Users may join the virtual audience of the broadcast performance via respective user terminals 6, for example by interacting with a graphical user interface. Each user may select or be assigned a respective virtual position, such as a seat, within the modelled performance venue. These selections may be made prior to, or during, the performance and users may also join or be assigned to respective user bubbles at this stage, for example based on a friends list and/or the virtual proximity of the users.

It shall be appreciated in this context that the virtual audience may be composed of thousands of audience members. The virtual audience may therefore be divided into a plurality of user bubbles (e.g. 1 to M user bubbles, where M is a positive integer) based on the user selections via the user terminals 6 and the virtual proximity of the audience members, i.e. the proximity of the respective virtual positions.

To give an example, FIG. 2 shows a virtual audience 10 comprising a plurality of audience members, each having a respective virtual position 12 inside a model 14 of a real-world performance venue. The performance venue takes the form of a football stadium in this example. The plurality of audience members includes first, second and third groups of friends, shown in FIG. 2, and the audience members of each friendship group wish to communicate with one another during the performance whilst enjoying the atmosphere created by the rest of the virtual audience 10. Each group of friends may therefore form a respective user bubble in the system based, at least in part, on their virtual proximity and user selections.

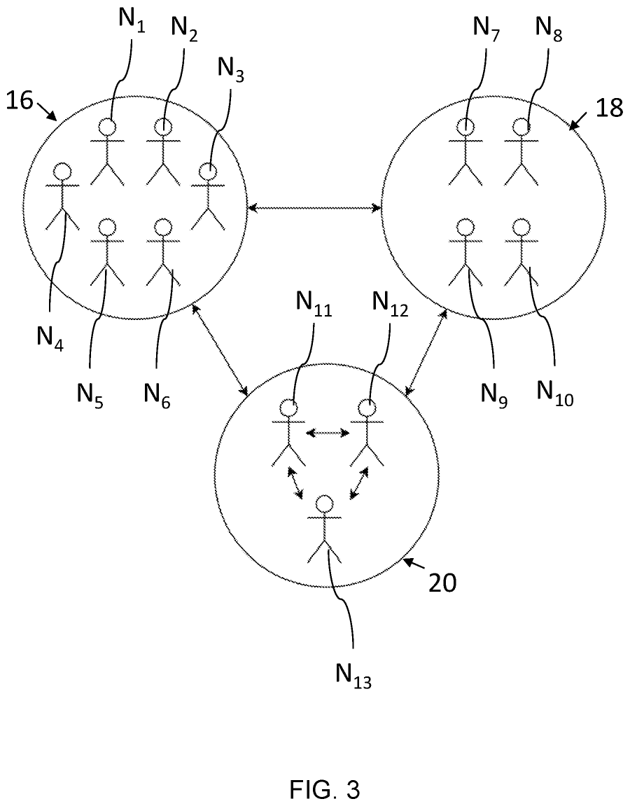

Hence, the first group of friends, composed of audience members N₁ to N₆, may be allocated to a first user bubble 16, as also shown in FIG. 3. The second group of friends, composed of audience members N₇ to N₁₁, may be allocated to a second user bubble 18 and the third group of friends, composed of audience members N₁₂ to N₁₄, may be allocated to a third user bubble 20.

As shown in FIG. 3, the first user bubble 16 therefore has six audience members, N₁ to N₆, that are able to communicate with each other during the performance and each user's audio signal is unique and individualised inside the first user bubble 16. The audio signals from the other user bubbles, such as the second and third user bubbles 18, 20, are processed separately and composited together to form respective extra-bubble audio signals that are received by the audience members, N₁ to N₆, of the first user bubble, providing a surrounding audience noise, as shall be discussed in more detail.

In order to perform the audio mixing and provide a realistic acoustic experience, each virtual position 12 is associated with one or more corresponding real-world positions and an associated set of acoustic characteristics corresponding to the real-world performance venue.

For example, the acoustic characteristics of the real-world performance venue may be determined for a plurality of real-world speaking/listening positions distributed around the performance venue. Each real-world position may be associated with one or more virtual positions 12 in the model 14. In an example, the virtual position 12 of each audience member may be associated with a respective individualised real-world speaking/listening position and a corresponding set of acoustic characteristics. Alternatively or additionally, in some examples, a group of virtual positions 12 in close proximity to one another, or a user bubble 16, 18, 20, may be associated with a common real-world speaking/listening position and the corresponding set of acoustic characteristics.

In each case, the set of acoustic characteristics associated with each virtual position 12 are able to accurately model a reverb signature or impulse response of the performance venue at the corresponding real-world position. The set of acoustic characteristics may therefore be used by one or more algorithms of the audio mixing system 1 to generate a reverb tail from an audio input signal.

For example, each set of acoustic characteristics may include, or be derived from, an impulse response (IR) and/or a binaural room impulse response (BRIR). In this context, the IR is a measurement of the response of a space or the resultant pressure fluctuation at a receiving point due to an (ideally) impulsive sound source in the performance venue. The BRIR is a type of IR further characterised by the receiver having the properties of a typical human head. In particular, the BRIR is characterised by the receiver having two independent channels of information separated appropriately, and subject to spatial variation imparted by the pinnae and head.

The IRs comprise the superposition of the direct source-to-receiver sound component, discrete reflections produced from interactions with a limited number of boundary surfaces, together with the densely distributed, exponentially decaying reverberant tail that results from repeated surface interactions. Therefore, the IRs are uniquely defined by the real-world position, shape and acoustic properties of reflective surfaces, together with the source and receiver position and orientation. As shall be appreciated by the skilled person in the art, the set of acoustic characteristics that define the IRs may therefore include: forward early reflections, reverse early reflections, Initial Time Delay Gap, and/or Late Reverberation, amongst others.

Accordingly, for each real-world position in the performance venue, the IRs describe how the performance venue responds to a full range of frequencies (typically 20 Hz to 20,000 Hz).

The acoustic characteristics associated with each virtual position 12 may be physically measured and/or computationally derived. For example, the acoustic characteristics may be physically measured for each real-world speaking/listening position and associated with a respective virtual position 12 or, for practical reasons, the acoustic characteristics may be physically measured for a limited number of real-world speaking/listening position, which may be associated with a respective group of virtual positions 12 or a user bubble 16, 18, 20.

The IRs may be physically measured at each real-world position in a performance venue according to various methods that are known in the art, including using a sound source to excite the space and recording equipment positioned at each corresponding real-world position. For example, the sound source may perform a sine sweep, which usually provides a desirable signal-to-noise ratio, or the sound source may be anything that creates a loud broadband burst of noise, such as a starter pistol, balloon or clapper board, in a transient method. Such a sound excites the reverberation (the response) in the space, and so the impulse response (or at least its initial recording) sounds like a burst followed by the reverb reflections of the space. The recording equipment should therefore capture the widest range of frequencies in the reverb reflections possible for as accurate a recreation as possible. For this purpose, the recording equipment used may, for example, take the form of a tetrahedral array microphone at the real-world position and the acoustic characteristics generated may take the form of Ambisonic B-format files with the dimensions: W, X, Y, Z. B-format files can be represented in stereo domain and retain all of the spatial properties of the recorded sound. A binaural decoder can be used for this purpose, which is based on a frequency response of the head, pinna and torso—typically referred to as a HRTF (Head Related transfer function)—which gives information about how a user's ear receives sound from any point of space. Once captured, depending on the algorithms used by the audio mixing system 1, the recorded IR may need to be processed to remove the original source sound, in a process called deconvolution.

In another example, the acoustic characteristics may be measured, substantially as described above, at a limited number of real-world positions dispersed around the performance venue and a set of acoustic characteristics may be computationally derived for each virtual position 12 based on the measured acoustic characteristics. For example, a respective set of acoustic characteristics may be computationally derived for each virtual position 12 based on the measured acoustic characteristics using one or more methods that are known in the art for interpolation and/or extrapolation. However, such methods are not discussed in detail here to avoid obscuring the invention.

In other examples, the set of acoustic characteristics may also be derived computationally, based on the model 14 of the performance venue. For example, methods are known in the art for computationally deriving an impulse response at one or more positions in a modelled space, such as the performance venue. In such examples, the impulse response may be derived based, in part, on the dimensions of the environment, expressed in length, height and width and the proximity of each virtual position relative to the boundaries or surfaces of the environment, for example calculated on x-, y-and z-axes. The functions for deriving the impulse response may also take into consideration the type of material that the environment surfaces and/or boundaries are made of and other parameters including the physical and virtual attendance; and/or the climate at the performance venue (temperature, humidity, etc.).

In each case, the IR measured at each real-world position may therefore be stored as a respective set of acoustic characteristics associated with one or more virtual positions 12 in the model 14 of the performance venue. During the subsequent audio mixing, one or more algorithms may be used to perform convolution of the audio input signals with the IR or BRIR to impart the reverberant characteristics of the performance venue onto the audio input signals, giving the perception of listening to that audio signal as if it were recorded in the real-world position.

During the broadcast, the audio mixing system 1 therefore receives one or more audio input signals via respective user terminals 6.

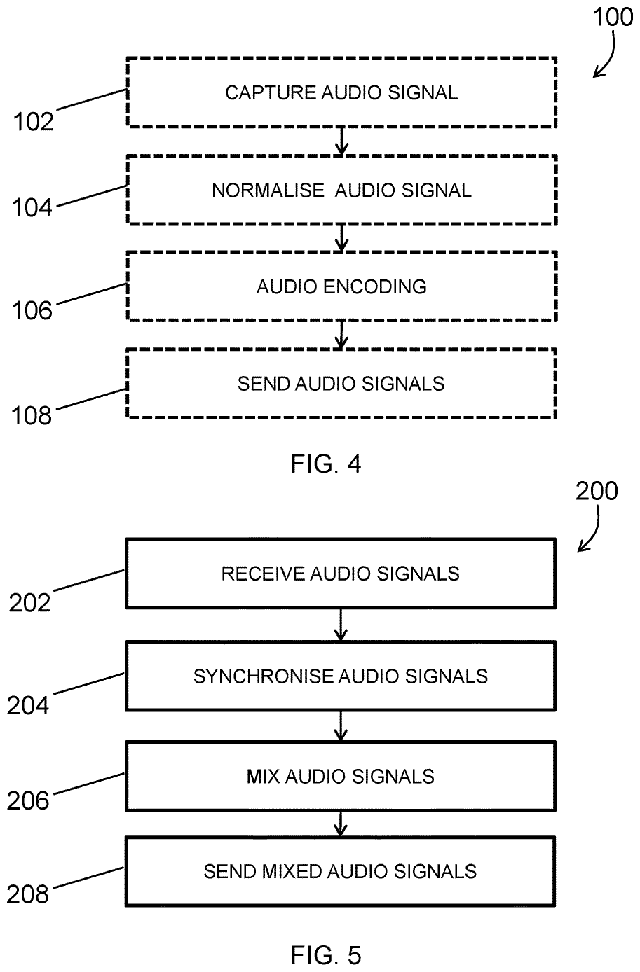

For context, FIG. 4 shows example steps, 102 to 108, involved in a method 100 of generating an audio input signal at an example user terminal 6.

In step 102, the user terminal 6 captures audio data from a respective user. For example, audio may be picked up via the microphone of the user terminal 6 as the user speaks, chants, claps or otherwise makes noise captured by the audio device. The user terminal 6 records the audio as a signal and timestamps the audio with the time of originating, for example according to a reference timeline of the broadcast audio and/or video signal(s) forming a time varying audio input signal.

Thereafter the user terminal 6 may perform one or more signal processing steps to improve the signal quality and/or to improve the transmissibility of the audio input signal.

In particular, in step 104, the user terminal 6 may normalise the audio input signal to remove background noise and unwanted spatial effects like echo. For this purpose, the user terminal 6 may use one or more signal processing or filtering methods that are known in the art for normalising audio signals, e.g. to remove such noise components and/or the unwanted spatial effects. Such methods are well known to the person skilled in the art but shall not be described in detail here to avoid obscuring the invention.

In step 106, the user terminal 6 may compress and encode the normalised audio input signal for efficient transmission via the communications network 8. For example, the user terminal 6 may apply one or more encoding techniques to convert the normalised audio input signal into a format, such as an AAC or opus format, for efficient transmission via a respective transport protocol of the communication network 8, which may include WebRTC, SRT1, RIST2 and/or HESP3 transport protocols, as discussed previously. Again, such methods are well-known to the skilled person in the art and are not described in detail here to avoid obscuring the invention.

In step 108, the user terminal 6 transmits the generated audio input signal to the mixer server(s) 4 via the communication network 8. For example, the encoded audio input signal may be transmitted to the mixer server(s) 4 via the communication network 8 using any of the transport protocols described above.

The process described above, in steps 102 to 108, may be performed for each audience member and the mixer-server(s) 4 of the audio mixing system 1 may therefore receive a plurality of such time-stamped audio input signals from respective user terminals 6.

In examples, the media source 2 may further generate and transmit audio and/or video signals for the broadcast performance, which may be compressed and encoded for transmission substantially as described in steps 106 to 108. The broadcast audio and/or video signals may, for example, be received at the mixer server(s) 4 concurrently with the audio input signals received from the user terminals 6.

Upon receiving the plurality of audio input signals, the mixer server(s) 4 are configured to process and mix the audio input signals to determine respective audio output signals for transmission to each of the user terminals 6 for synchronous playback with the broadcast audio and/or video signals.

FIG. 5 therefore shows example steps of a method 200 for mixing the audio for the virtual audience of the broadcast performance, in accordance with an embodiment of the invention.

In step 202, the mixer server(s) 4 receive a plurality of audio inputs signals from the user terminals 6. Upon receiving the audio input signals, the mixer server(s) 4 may apply one or more decoding and/or transmuxing techniques for decompressing each audio input signal and converting the audio input signals from a format that is suitable for the transport protocol to a format that is suitable for subsequent audio mixing. The methods for decoding and/or transmuxing the received signals are well-known to the skilled person in the art and are not described in detail here to avoid obscuring the invention.

It shall be appreciated that, in examples, the audio input signals may be received from each user terminal 6 in synchronous form with one another, in step 202, for example where the user terminals 6 are configured to synchronise the audio input signals with the reference timeline prior to transmission. In this respect one or more companion service applications may synchronise the audio input signals with a common reference timeline of the broadcast audio/video signals using and account for respective latencies.

In other examples, the mixer server(s) 4 may alternatively or additionally synchronise the received audio input signals with the reference timeline, in step 204, upon receipt of the timestamped signals. For this purpose, the mixer server(s) 4 may use one or more synchronisation methods, schemes or protocols that are known in the art, such as those described in ETSI TS 103286-2 for content identification, timeline synchronization and/or the use of trigger events.

Following steps 202, and optionally 204, the mixer server(s) 4 therefore obtains a plurality of synchronous audio input signals ready for application of the subsequent audio mixing techniques.

In step 206, the audio mixing system 1 mixes the audio inputs signals together to generate respective audio output signals for each user terminal 6.

The audio input signals may be mixed by the mixer-server(s) 4 according to one or more methods within the scope of the invention and it is envisaged that the most appropriate method may depend on the number of audience members in the virtual audience.

In an example, the mixer server(s) 4 may process all of the audio input signals together using the relative virtual positions and the associated set of acoustic characteristics, without the need for intermediate mixing of respective user bubbles.

Typically though, the virtual audience may include thousands (e.g. ten of thousands) of audience members, as in the present example. In this situation the bandwidth capabilities of the mixer server(s) 4 may be insufficient to process every audio input signal together when determining respective audio output signals for each of the audience members without unacceptable delays (i.e. greater than 200 ms as is perceptible to the human ear).

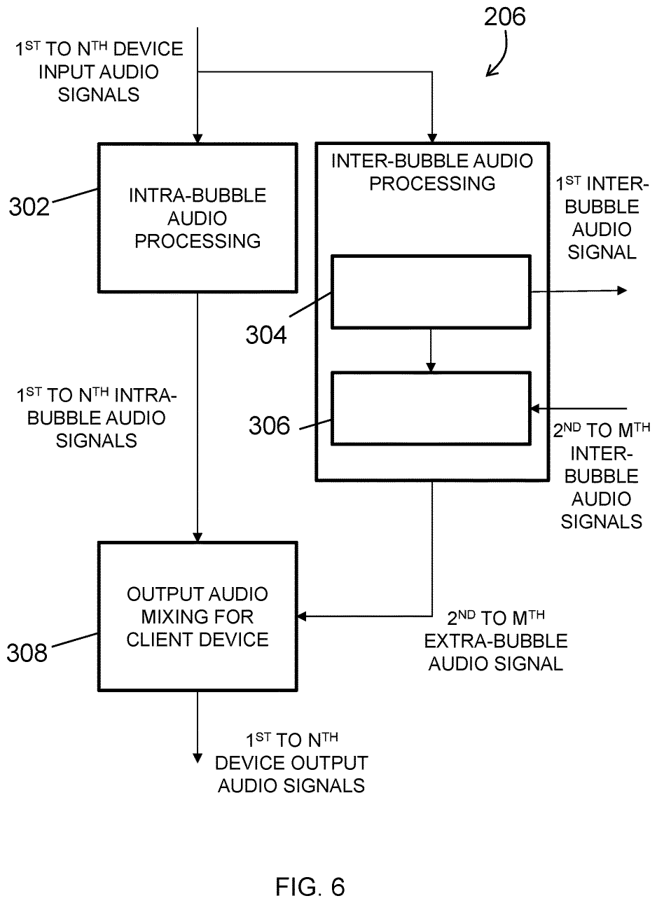

Accordingly, when the virtual audience is greater than a threshold, such as one hundred audience members, the mixer server(s) 4 may be configured to mix the audio input signals according to another method, as shall be described in more detail below with reference to FIG. 6.

In particular, the mixer server(s) 4 may be configured to mix the audio input signals by performing: (i) intra-bubble audio processing; (ii) inter-bubble audio processing; and (iii) output audio mixing.

By way of example, FIG. 6 shows example sub-steps 302 to 308 for mixing the synchronised audio input signals for each user terminal 6 of the first user bubble.

In general, the mixer server(s) 4 may therefore receive 1 to N input audio signals from the audience members of a particular user bubble, where N is a positive integer. Taking the first user bubble 16 as an example, the mixer server(s) 4 may therefore receive up to six audio input signals from the first user bubble 16 at any one time (i.e. N=6).

In sub-step 302, the mixer-server(s) 4 performs intra-bubble audio processing on the 1 to N audio input signals of the example first user bubble 16 to impart the reverberant characteristics of the real-world performance venue on the audio transmitted from the respective virtual positions 12.

For example, the mixer server(s) 4 may apply one or more algorithms, such as one more convolution algorithms, to adjust each of the 1 to N audio input signals based on the respective set of acoustic characteristics associated with the respective virtual position 12 of each of the 1 to N audience members (i.e. audience members N₁ to N₆). The convolution algorithm may, for example, add a corresponding reverberant tail to each of the 1 to N audio input signals, thereby forming a set of 1 to N intra-bubble audio signals.

Simultaneously, and/or separately, the mixer-server(s) 4 perform inter-bubble audio processing in sub-steps 304 and 306.

In particular, in sub-step 304, the mixer server(s) 4 aggregate the audio input signals 1 of each user bubble together to form a respective inter-bubble audio signal for each user bubble i.e. producing 1 to M inter-bubble audio signals, where M is a positive integer corresponding to the number of user bubbles in the virtual audience.

Accordingly, taking the first user bubble 16 as an example, the mixer server(s) 4 aggregate the 1 to N audio input signals together to form a composite audio signal, in the form of a first inter-bubble audio signal, which is distributed externally to the other user bubbles, 2 to M. It shall be appreciated that in this instance, the acoustic characteristics have not been applied to the 1 to N audio input signals, which are instead combined in their raw form for efficient processing. For this purpose, the mixer-server(s) 4 may use one or more aggregation or compositor techniques that are known in the art for combining audio signals. The first intra-bubble audio signal is provided to the other user bubbles (2 to M), such as the second and third user bubbles 18, 20, to convey a sound input from the audience members, N₁ to N₆, of the first user bubble 16.

In sub-step 306, the mixer-server(s) 4 imparts the reverberant characteristics of the real-world performance venue on the audio transmitted from each of the other user bubbles, 2 to M. For example, the mixer server(s) 4 may apply one or more algorithms (e.g. one more convolution algorithms), substantially as described previously, to adjust each of the 2 to M inter-bubble audio signals based on the respective set of acoustic characteristics associated with the respective virtual position 12 of each of the 2 to M user bubbles. In this context it shall be appreciated that a central, preprogramed or otherwise designated, one of the virtual positions 12 of each user bubble may be considered to be representative of a virtual position 12 of that user bubble. In other examples, a representative virtual position may be determined based on the individual virtual positions of each audience member of that user bubble. The set of acoustic characteristics associated with that representative virtual position may therefore be considered as representative of the real-world acoustic response for that user bubble. Accordingly, the convolution algorithm may, for example, add a corresponding reverberant tail to each of the 2 to M inter-bubble audio signals based on the respective sets of acoustic characteristics, thereby forming a set of 2 to M extra-bubble audio signals.

In sub-step 308, the mixer-server(s) 4 perform output audio mixing to determine respective audio output signals for each user terminal 6 of the example first user bubble 16 based on the 1 to N intra-bubble audio signals and the 2 to M extra-bubble audio signals.

The output audio mixing therefore adjusts each of the 1 to N intra-bubble audio signals and 2 to M extra-bubble audio signals to account for spatial differences between the virtual speaking and listening positions and to impart the real-world frequency-specific reverberant characteristics of the listening position of the respective receiving user terminal 6.

For example, for each user terminal 6 of the example first user bubble 16, the mixer server(s) 4 may adjust each of the 1 to N intra-bubble audio signals and 2 to M extra-bubble audio signals to impart the reverberant characteristics of the real-world performance venue at the receiving positions of the user terminal 6. In particular, the mixer server(s) 4 may apply one or more algorithms, such as one or more convolution algorithms, to adjust each of the 1 to N intra-bubble audio signals and 2 to M extra-bubble audio signals based on the respective set of acoustic characteristics associated with the respective virtual position 12 of the receiving audience members. The convolution algorithm may, for example, add a corresponding reverberant tail to each signal.

To account for the relative transmitting and receiving positions, for each user terminal 6 of the example first user bubble 16, the mixer server(s) 4 may further apply one or more transfer functions, such as a head related transfer function, to each of the 1 to N intra-bubble audio signals, relating the respective virtual positions 12 of the receiving audience member to the transmitting audience member.

In a similar manner, the mixer server(s) 4 may also apply one or more transfer functions, such as a head related transfer function, to each of the 2 to M extra-bubble audio signals, relating the respective virtual positions 12 of the receiving user bubble to the transmitting user bubbles.

The output is therefore an individualised audio output signal to be transmitted to each user terminal 6 of the example first user bubble 16. The sub-steps 302 to 308 are executed simultaneously for each user bubble (1 to M) and therefore the mixer-sever(s) 4 generate respective audio output signals for transmission to each user terminal 6.

Returning to FIG. 5, in step 208, the mixer server(s) 4 transmit the audio output signals to the respective user terminals 6. For example, the mixer server(s) 4 may apply one or more encoding and/or transmuxing techniques for compressing each audio output signal and converting the audio output signals to a format that is suitable for the transport protocol before transmitting each audio output signal via the communication network 8.

Each user terminal 6 therefore receives the audio output signal, and the audio may be played back via one or more connected speakers, such as a pair of headphones, synchronous with the play back of the audio and/or video signals from the media source 2. It shall be appreciated that the audio inputs signals from a particular user terminal 6 may be subtracted or otherwise excluded from playback on that user terminal 6, so that the user does not hear themselves speaking. This subtraction may be performed during the audio mixing or upon receipt of the audio output signal, for example.

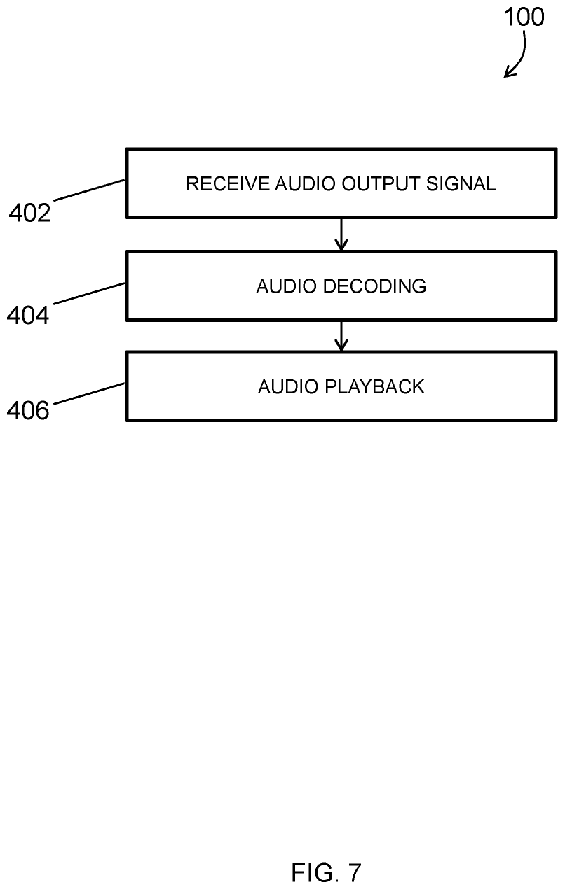

For context, FIG. 7 shows example steps, 402 to 406, of a method of processing an audio output signal for playback on an example user terminal 6.

In step 402, the user terminal 6 receives the audio output signal from the mixer server(s) 4.

In step 404, the user terminal 6 may decompress and decode the audio output signal for playback on the speaker(s) and/or the display screen(s). For example, the user terminal 6 may apply one or more decoding techniques to convert the audio output signal from a format, such as an AAC or opus format, for efficient transmission via a respective transport protocol of the communication network 8 to a format suitable for spatialised audio playback. Again, such methods are well-known to the skilled person in the art and are not described in detail here to avoid obscuring the invention.

In step 406, the user terminal 6 plays the audio output signal synchronously with the broadcast video signal. For example, the user terminal 6 may playback the broadcast video signal on the connected video device, showing the football match, and play the received audio output signal synchronously with the broadcast video signal to provide an immersive acoustic experience.

Again, it shall be appreciated that, in examples, the audio output signals may be received in synchronous form with the broadcast audio and/or video signals, in step 402, or one or more companion service applications may be used to account for respective latencies, synchronising the audio output signals with a common reference timeline of the broadcast audio/video signals.

In this manner, each user can enjoy the broadcast performance and listen to a spatialised sound output that accurately reproduces the acoustic qualities of the real-world performance venue, providing a more immersive experience for enjoying broadcast performances.

It will be understood that each step of the methods described above, and/or combinations of such steps can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the steps in the methods. Such computer program instructions may also be stored in a computer readable medium that can direct a computer, other programmable data processing apparatus, or other devices to function in a particular manner, such that the instructions stored in the computer readable medium produce an article of manufacture including instructions which implement the steps specified in the methods.

It is further noted that the steps of the methods described above are only provided as a non-limiting example of the disclosure though and many modifications may be made to the above-described examples without departing from the scope of the appended claims.

For example, in the examples described above the method is described in terms of centralised processing of the audio signals. However, in other examples, one or more aspects of the audio mixing may be performed locally on each user terminal 6. For example, each user terminal 6 may be configured to send a captured audio input signal to the mixer server(s) for inter-bubble audio processing, according to sub-steps 304 and 306, whilst separately performing the intra-bubble audio processing techniques, substantially as described in step 302, to form a respective intra-bubble audio signal for transmission to the other user terminals 6 of its respective user bubble. Each user terminal may therefore also receive 1 to N intra-bubble audio signals from the other N audience members of the user bubble, which may be routed accordingly via the mixer server(s) 4 for example.

The mixer server(s) 4 may also distribute the 2 to M extra-bubble audio signals, determined in sub-step 306, to each user terminal 6 of a particular user bubble. Hence, each user terminal 6 of a respective user bubble may receive the 1 to N intra-bubble audio signals of the other user terminals 6 in the user bubble and the 2 to M extra-bubble audio signals from the other user bubbles and mix such audio signals on the user terminal 6, substantially as described in sub-step 308, to determine the respective audio output signal, including the spatialised adjustments and reverberant sound characteristics of the respective virtual listening position.

The advantage of using local processing is the usage of the processing power of each user terminal 6. This decreases the need for centralised processing power, and thus reduces the complexity and cost of the mixer-server(s) 4. On the other hand, using consumer devices for audio mixing processes may limit the quality compared to the capabilities of dedicated mixer server(s) 4 and there may be substantial variation in the capacity and capabilities of individual user terminals 6.

Moreover, various architectures are envisaged for the mixer-sever(s) 4. For example, a cloud-based computing environment is generally considered as a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

Accordingly, one or more steps of the methods described above may be performed by third party cloud-based resources having different owners. For example, it is envisaged that third party mixer server(s) 4 may be utilised for the distribution aspects of the invention, in particular for efficient distribution of the audio signals via the communication network 8.

1. A computer-implemented method of mixing audio for a virtual audience of a broadcast performance, individual audience members of the virtual audience participating via respective user terminals, each audience member having a respective virtual position in a model of a real-world performance venue for sending and/or receiving audio signals, the virtual positions being associated with respective sets of acoustic characteristics for modelling acoustic responses of the real-world performance venue at corresponding real-world positions, the method comprising:
obtaining a plurality of audio input signals sent from respective audience members, each audio input signal being captured via the respective user terminal; and
determining one or more audio output signals for output to respective receiving audience members via the respective user terminals, each audio output signal being determined by adjusting one or more of the plurality of audio input signals to account for:
(i) the respective sets of acoustic characteristics associated with the virtual positions of the audience members sending and receiving that audio input signal; and
(ii) a spatial relationship between the virtual positions of the audience members respectively sending and receiving that audio input signal.

2. A method according to claim 1, further comprising:
obtaining one or more time-stamped broadcast audio and/or video signals from a media source broadcasting the performance; and
outputting the one or more audio output signals to the respective receiving audience members, via the respective user terminals, synchronously with the one or more broadcast audio and/or video signals.

3. A method according to claim 1, wherein each set of acoustic characteristics comprises one or more parameters of an impulse response of the performance venue at the corresponding real-world position.

4. A method according to claim 3, wherein the impulse response is a binaural room impulse response of the performance venue at the corresponding real-world position.

5. A method according to claim 3, wherein one or more of the sets of acoustic characteristics are determined by physically measuring the impulse response of the real-world performance venue at the corresponding real-world position.

6. A method according to claim 3, wherein one or more of the sets of acoustic characteristics are computationally derived, optionally, based on one or more physical measurements of the impulse response of the performance venue.

7. A method according to claim 1, further comprising associating the virtual audience with a plurality of user bubbles, each user bubble being associated with two or more of the audience members, wherein determining each audio output signal for output to the respective receiving audience member comprises:
identifying the user bubble associated with that receiving audience member;
adjusting the audio input signals sent from the other audience members of the identified user bubble according to a first audio processing method; and
adjusting the audio input signals sent from the audience members of the other user bubbles according to a second audio processing method.

8. A method according to claim 7, wherein the first audio processing method comprises:
adjusting each audio input signal sent from one of the audience members of that user bubble to account for the respective set of acoustic characteristics associated with the virtual position of that audience member, thereby forming a respective intra-bubble audio signal for each audience member of the identified user bubble.

9. A method according to claim 7, wherein each user bubble has a virtual position in the modelled performance venue, and a respective set of acoustic characteristics, based on the audience members associated with that user bubble and wherein the second audio processing method comprises:
compositing the audio input signals sent from the audience members of each of the other user bubbles into a respective inter-bubble audio signal for each user bubble and
adjusting each inter-bubble audio signal to account for the respective set of acoustic characteristics associated that user bubble, thereby forming a respective extra-bubble audio signal for each user bubble.

10. A method according to claim 8, wherein determining each audio output signal for output to the respective receiving audience member further comprises:
adjusting each intra-bubble audio signal to account for: (i) the set of acoustic characteristics associated with the virtual position of the audience member receiving that audio output signal, and (ii) the spatial relationship between the virtual position of the audience member sending that intra-bubble audio signal and the virtual position of the audience member receiving that audio output signal; and
adjusting each extra-bubble audio signal to account for: (i) the set of acoustic characteristics associated with the virtual position of the audience member receiving that audio output signal, and (ii) the spatial relationship between the virtual position of the user bubble sending that extra-bubble audio signal and the virtual position of the audience member receiving that audio output signal.

11. A method according to claim 7, wherein the first and second audio processing methods are executed simultaneously.

12. A method according to claim 1, wherein the audio signal adjustments to account for the respective set of acoustic characteristics comprise applying one or more convolution algorithms to convolute the respective audio signal with the respective set of acoustic characteristics.

13. A method according to claim 1, wherein the audio signal adjustments to account for the spatial relationships between the respective virtual positions (12) of the sending and receiving audience members comprise applying one or more transforms to the audio signal according to the respective spatial relationship.

14. A method according to claim 1, wherein the determined one or more audio output signals are three-dimensional signals.

15. A method according to claim 1, wherein the steps of obtaining the plurality of audio input signals and determining the one or more audio output signals are performed centrally on one or more mixer-servers.

16. An audio mixing system comprising:
a media source for broadcasting a performance;
one or more mixer servers; and
a plurality of user terminals operably connected to the one or more mixer servers via a communication network;
wherein a virtual audience is formed for the broadcast performance by a plurality of audience members participating via respective ones of the plurality of user terminals, each audience member having a respective virtual position in a model of a real-world performance venue, and the virtual positions being associated with respective sets of acoustic characteristics for modelling acoustic responses of the performance venue at corresponding real-world positions;
wherein the one or more mixer-servers are configured to execute instructions to:
obtain a plurality of audio input signals sent from respective audience members during the broadcast performance, each audio input signal being captured via the respective user terminal;
determine one or more audio output signals for output to respective receiving audience members via the respective user terminals each audio output signal being determined by adjusting one or more of the plurality of audio input signals to account for: (i) the sets of acoustic characteristics associated with the virtual positions of the audience members respectively sending and receiving those audio input signals; and
(ii) a spatial relationship between the virtual positions of the audience members respectively sending and receiving those audio input signals.

17. An audio mixing system according to claim 16, wherein each user terminal comprises one or more audio devices for:
capturing audio from a user to generate audio input signals; and
playback of audio output signals to the user.

18. An audio mixing system according to claim 16, wherein each user terminal comprises one or more video devices for playback of one or more time-stamped broadcast audio and/or video signals generated by the media source.

19. An audio mixing system according to claim 16, wherein the media source is configured to generate one or more time-stamped broadcast audio and/or video signals; and
wherein the one or more mixer-servers are configured to execute instructions to output the one or more audio output signals to the respective receiving audience members, via the respective user terminals, synchronously with the one or more broadcast audio and/or video signals.

20. A computer-implemented method of mixing audio for an audience member of a broadcast performance, the audience member being part of a virtual audience along with a plurality of connected audience members, the audience member and each connected audience member participating via a respective user terminal and having a respective virtual position in a model of a real-world performance venue, the virtual positions being associated with respective sets of acoustic characteristics for modelling acoustic responses of the real-world performance venue at corresponding real-world positions, the method comprising:
obtaining a plurality of audio input signals sent from the connected audience members, each audio input signal being captured via the respective user terminal and adjusted to account for the set of acoustic characteristics associated with the virtual position of the connected audience members sending that audio input signal; and
determining an audio output signal for output to the audience member via the respective user terminal, the audio output signal being determined by adjusting one or more of the plurality of audio input signals to account for:
(i) the set of acoustic characteristics associated with the virtual position of the audience member receiving the audio output signal; and
(ii) a spatial relationship between the virtual positions of the receiving audience member and the connected audience member sending that audio input signal.
